(19) United States
(12) Patent Application Publication
(10) Pub. No.: US 2011/0103462 A1
(43) Pub. Date: May 5, 2011

(54) SYSTEM, METHOD AND COMPUTER PROGRAM PRODUCT FOR IMAGE AND VIDEO TRANSCODING

(75) Inventors: Krasimir D. Kolarov, Menlo Park, CA (US); Steven E. Saunders, Cupertino, CA (US); Thomas Allen Darbonne, Santa Cruz, CA (US)

(73) Assignee: DROPLET TECHNOLOGY, INC., Palo Alto, CA (US)

(21) Appl. No.: 12/791,812

(22) Filed: Jun. 1, 2010

Related U.S. Application Data
(63) Continuation of application No. 10/418,649, filed on Apr. 17, 2003, now abandoned.
(60) Provisional application No. 60/374,069, filed on Apr. 19, 2002.

(51) Int. Cl. H04N 7/26

(52) U.S. Cl. 375/240.01; 375/E07.026

(57) ABSTRACT

A system and method are provided for compressing data. Initially, data is received in a single device. Such data is encoded utilizing the single device to generate first compressed data in a first format. Moreover, the first compressed data is transcoded utilizing the single device to generate second compressed data in a second format.

### RELATED APPLICATION(S)

The present application is a continuation of application Ser. No. 10/418,649, filed on Apr. 17, 2003, which claims priority from a provisional application filed Apr. 19, 2002 under Ser. No. 60/374,069, all of which are incorporated herein by reference in their entirety.

### FIELD OF THE INVENTION

The present invention relates to data compression, and more particularly to compressing data utilizing wavelets.

### BACKGROUND OF THE INVENTION

Digital image capture, storage, transmission, processing, and display are becoming widespread in our everyday experience; digital video is likewise beginning to be widespread. Mobile devices, including cell phones, personal digital assistants (PDAs, such as Palm Computing products), laptop PCs, wireless PCs, and others, are coming to have cameras in them for taking pictures and capturing video sequences. Cameras, both still and video, are coming to have communication functions built in.

Mobile and personal electronic devices share the property that they are powered by batteries, whose weight and size and cost are very important in their designs. Reducing the power consumption of any part of the function of these devices is highly valuable.

In many cases, the power consumption is driven not by the average functional usage but by the peak capabilities that may be required only rarely. Circuits that must be designed with the capacity to execute a lot of processing very fast take more power than circuits that do similar operations at a slower pace.

Images and video captured digitally take large amounts of digital storage to hold. For this reason, images and video are often compressed for storage and compression. The compression process, in order to compress by large factors, usually discards some information (or, equivalently, adds some noise) in a way that allows sufficient visual quality to suit the users' needs.

Mobile devices that transmit information wirelessly, such as cell phones, face severe limits on the speed at which information can be transmitted. For present-day telephone networks, the rate is far lower than is needed for real-time or broadcast video of a quality that customers seem interested in, even with the best compression methods available. This fact leads to a multiplicity of modes in which images and video can be used other than straight “videophone” or real-time conversation.

Devices that connect through wired, rather than wireless, communication networks also face limitations on transmission speed in many situations. Therefore all the improvements described here should be understood to apply in wired, as well as wireless, situations whenever transmission speed or transmission cost is a limiting factor.

While there are many proprietary methods for still image compression, there is a dominant international standard called JPEG, and a new standard JPEG-2000 is emerging and is likely to become dominant.

JPEG compression, and to an even greater extent JPEG-2000, are expensive to compute. This means that devices using these methods require fast chips, considerable memory, and significant power consumption if compression is to be performed rapidly.

While there are many proprietary methods for video compression, the dominant standards are the MPEG family: MPEG-1 and MPEG-2 for broadcast, cable, and DVD uses, and MPEG-4 for a broader range of uses including wireless networks

The MPEG family of video compression standards is quite expensive to compute; their basic steps of DCT (Discrete Cosine Transform) and Motion Search require large numbers of multiplication and summation operations. Integrated circuits are presently being made that implement these compression methods, but they take relatively large amounts of power to operate. The MPEG family of compression methods are designed to be asymmetric: they require much more computation to do the compression than to do the decompression. This design is based on the broadcast model of video distribution, which was reasonable when the standards were designed and remains reasonable for many situations. However, it does not match the situation of mobile, personal devices with cameras in them.

There are many non-standard, proprietary algorithms for video compression. Most of them offer advantages over the MPEG standards in either compression ratio, picture quality, or both; most of them are at least as asymmetric as the MPEG family. That is, although some can be decompressed for viewing with very low computational complexity, nearly all of them require large amounts of computation when doing the compression operation.

It is possible to design and implement video compression that offers comparable compression ratios and picture quality to the MPEG family of standards, while far less computational complexity to compress the captured video than any MPEG or MPEG-like method. Such a compression method is wavelet-based.

These methods derive their computational efficiency from their avoidance of the two highly expensive steps in MPEG-like methods, DCT and motion search.

However, in many situations such as cell phone networks, it is desirable that transmissions be in a standard format so that devices from different manufacturers, or on different networks, or in different countries, can communicate with each other.

### DISCLOSURE OF THE INVENTION

A system and method are provided for compressing data. Initially, data is received in a single device. Such data is encoded utilizing the single device to generate first compressed data in a first format. Moreover, the first compressed data is transcoded utilizing the single device to generate second compressed data in a second format.

In one embodiment, the encoding may occur in real-time. Moreover, the transcoding may occur off-line.

In another embodiment, the first compressed data may be transcoded to generate the second compressed data in the second format such that the second compressed data is adapted to match a capacity of a communication network coupled to the single device.

As an option, the encoding may be carried out utilizing a first encoder. Moreover, the transcoding may be carried out utilizing a decoder and a second encoder.

Still yet, the first format may include a wavelet-based format. Further, the second format may include a DCT-based format. In one particular embodiment, the second format may include an MPEG format.

### BRIEF DESCRIPTION OF THE DRAWINGS

FIG. 1 illustrates a system for compressing data, in accordance with one embodiment.

FIG. 2 illustrates a framework for compressing/decompressing data, in accordance with one embodiment.

FIG. 3 illustrates a method for compressing/decompressing data, in accordance with one embodiment.

FIG. 4 shows a data structure on which the method of FIG. 3 is carried out.

FIG. 5 illustrates a method for compressing/decompressing data, in accordance with one embodiment.

### DESCRIPTION OF THE PREFERRED EMBODIMENTS

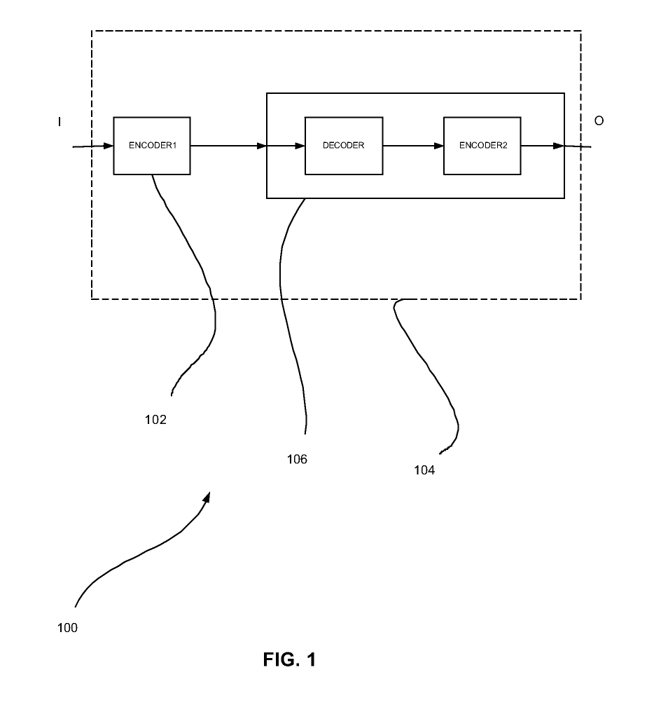

FIG. 1 illustrates a system 100 for compressing data, in accordance with one embodiment. Included is an encoder 102 embodied on a single device 104 for encoding data to generate first compressed data in a first format. Moreover, a transcoder 106 is embodied on the same single device 104 as the encoder 102 for transcoding the first compressed data to generate second compressed data in a second format.

In use, data is received in the single device 104. Such data is encoded utilizing the single device 104 to generate first compressed data in a first format. Moreover, the first compressed data is transcoded utilizing the single device 104 to generate second compressed data in a second format.

In one embodiment, the encoding may occur in real-time. Moreover, the transcoding may occur off-line. In another embodiment, the first compressed data may be transcoded to generate the second compressed data in the second format, such that the second compressed data is adapted to match a capacity of a communication network coupled to the single device 104.

As an option, the encoding may be carried out utilizing a first encoder. Moreover, the transcoding may be carried out utilizing a decoder and a second encoder, as shown in FIG. 1.

Still yet, the first format may include a wavelet-based format. Further, the second format may include a DCT-based format. In one particular embodiment, the second format may include an MPEG format. More exemplary information regarding additional optional features will now be set forth.

As set forth earlier, there are several modes of communication using images and video sequences. In addition to direct real-time viewing, one can capture the image(s) or video sequence and transmit it at a later time, either immediately following capture or delayed until a more advantageous time.

In addition, the receiving of a video sequence can be done either in a real-time mode in which the video seen but not stored, like watching TV, or in another mode where the sequence is stored for later viewing.

These various options combine into three scenarios of use, in addition to other combinations. The three scenarios are:

Videophone or picturephone operation as described above, where both the transmitter and receiver operate in real time. This requires all compression, coding, and decompression to be done in real time at the speed of video capture, and it requires the transmission channel to carry the full rate of the compressed video.

Streaming operation, in which the video is captured and stored at the source or in the network and viewed at the receiver in real time. This requires real-time decoding, but allows time for processing the sequence before transmission. This mode requires the transmission channel, at least from the network to the receiver, to carry the full rate of the compressed video. In addition, for most transmission channels, the receiver must buffer some amount of the sequence to maintain smooth playback in the presence of variance in the transmission rate.

Messaging or File-transfer mode, in which the video is captured and stored at the source, transferred in non-real-time to the receiver, and stored at the receiver for later playback. This mode allows for operation on transmission channels that cannot carry the full rate of real-time video, and allows for the recipient to replay, pause, and otherwise control the experience.

Images or video that have been captured and compressed in one format may be converted into another compression format. This operation is called transcoding. It is done, in the worst case, by decompressing the input format into a full picture or video, then compressing in the desired output format. For many pairs of formats there may be less-expensive methods than this worst-case method available.

In many networks, such as the international cell phone network, different users may prefer or require different formats for images or video. This may be the case even if all users adhere, for example, to the MPEG-4 standard, because that standard offers many options of profiles, size, rate, and other parameters. For this reason and others it will sometimes be desirable for the sender and recipient devices to negotiate which format is to be used in a particular transmission. In the simplest case each device provides a list of formats that it can handle, and both choose one that is mutually acceptable from the intersection of the lists. There are more complex forms of this negotiation, but the general effect is the same: the sender only knows what format to transmit after the start of the connection.

When transcoding is required as part of a connection, it can be performed either in the originating device or in some intermediate location. Some networks may offer transcoding services as part of the operation of the network, in order to provide for mutual communication among devices with disparate local capabilities. This will help to keep the complexity, and hence the cost, of the mobile units low.

Because of the disparities mentioned above between video data rates and transmission channel rates, it can be advantageous to operate in a new mode as follows. The device captures video, compresses it in real time using a low-complexity compression method such as that to be described hereinafter, and stores the compressed video sequence. Then at a later time the device can transcode the video sequence into a format that is acceptable to the recipient or to the network. This allows for low power operation, long battery life, and simpler circuitry in the device, along with complete compatibility with network format standards.

An optional advantage of this operating style is flexibility: the choice of real-time compression does not limit the range of receivers with which the device can communicate directly. The transmission format can be negotiated at the time of the transfer call, as described above. The device can support a broader range of formats this way, because it need not have an extensively optimized real-time implementation of every one.

Another optional advantage of the operating style above is that the transcoding need not operate at the speed of video capture, but can be matched to the speed of the transmission network which is often much lower. The lower speed transcoding operation, in turn, can be done in circuitry that is smaller and consumes less power than a standard real-time compressor would take. Thus the overall power consumption, battery life, complexity, and cost of the device is reduced.

Yet another optional advantage of this style of operation is the possibility of postponing transmission of images and video from times when the cost is high, such as daytime telephone rates, to times when the cost is lower (or, in current cell phone pricing schemes, even free) such as night rates.

The transmission may have lower cost at another time because of other factors than time. For example, a cell phone may incur lower charges when it returns to its home territory than when it is “roaming”.

Deferred transmission as described does not necessarily require the user of the device to take any deferred action. The transmission can be scheduled automatically by the device, based on information it has about rates and schedules. Thus the user's convenience is preserved.

Of course, some messages have higher perceived urgency than others; users can easily specify whether and how long to defer transmission.

When images and video are transferred in non-real time, it is possible that the user of the device will want to make a call while the transfer is in progress, or that an incoming call will arrive, or that the connection will be broken for some other reason. It is well known in the computer networking field to provide information that allows an interrupted transfer to resume, without having to retransmit parts of the information that were already successfully transferred.

Such interruptible transfers will allow both for deliberate interruption such as placing a call and for unexpected interruption such as a dropped connection.

It is not necessary for the receiving device to have the capacity to store an entire video sequence. A transcoding source device can send to a streaming-mode receiver, including a receiver that is much simpler and much less capable than the sender. This allows for easy adoption of advanced transcoding devices into an existing network of devices.

Standard image and video formats provide error detection, error correction, and burst-error control methods. By transcoding into these standard formats, the device can take full advantage of standard error resilience features while using a low-complexity, low-power capture compression method.

The idea of capturing a signal of interest using low-complexity real-time processing, then transcoding it later into a format better suited to transmission, storage, or further processing, can be applied to signals other than images and video, and to uses other than wireless transmission, and to devices other than mobile personal conveniences. For example, military intelligence sensing, infrared remote sensing, sonar, telescope spectra, radio telescope signals, SETI channels, biochemical measurements, seismic signals, and many others can profit from this basic scheme.

More information regarding an optional framework 200 in which the present embodiment may be implemented will now be set forth.

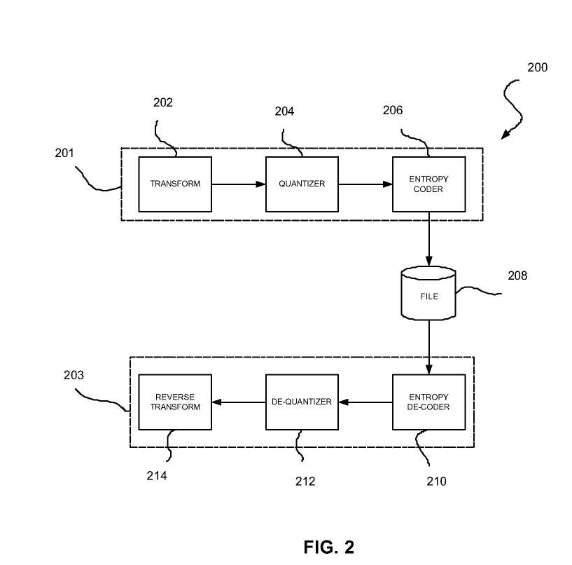

FIG. 2 illustrates a framework 200 for compressing/decompressing data, in accordance with one embodiment. Included in this framework 200 are a coder portion 201 and a decoder portion 203, which together form a “codec.” The coder portion 201 includes a transform module 202, a quantizer 204, and an entropy encoder 206 for compressing data for storage in a file 208. To carry out decompression of such file 208, the decoder portion 203 includes a reverse transform module 214, a de-quantizer 212, and an entropy decoder 210 for decompressing data for use (i.e. viewing in the case of video data, etc).

In use, the transform module 202 carries out a reversible transform, often linear, of a plurality of pixels (in the case of video data) for the purpose of de-correlation. Next, the quantizer 204 effects the quantization of the transform values, after which the entropy encoder 206 is responsible for entropy coding of the quantized transform coefficients.

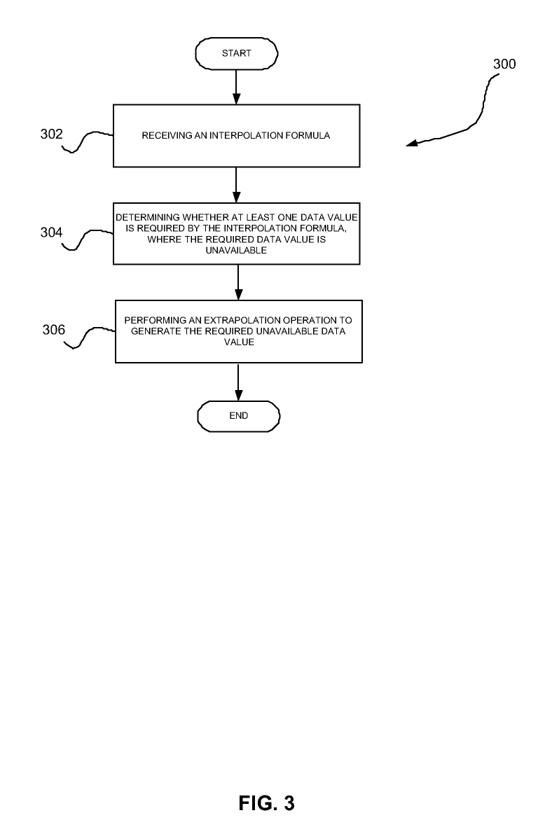

FIG. 3 illustrates a method 300 for compressing/decompressing data, in accordance with one embodiment. In one embodiment, the present method 300 may be carried out in the context of the transform module 202 of FIG. 2 and the manner in which it carries out a reversible transform. It should be noted, however, that the method 300 may be implemented in any desired context.

In operation 302, an interpolation formula is received (i.e. identified, retrieved from memory, etc.) for compressing data. In the context of the present description, the data may refer to any data capable of being compressed. Moreover, the interpolation formula may include any formula employing interpolation (i.e. a wavelet filter, etc.).

In operation 304, it is determined whether at least one data value is required by the interpolation formula, where the required data value is unavailable. Such data value may include any subset of the aforementioned data. By being unavailable, the required data value may be non-existent, out of range, etc.

Thereafter, an extrapolation operation is performed to generate the required unavailable data value. See operation 306. The extrapolation formula may include any formula employing extrapolation. By this scheme, the compression of the data is enhanced.

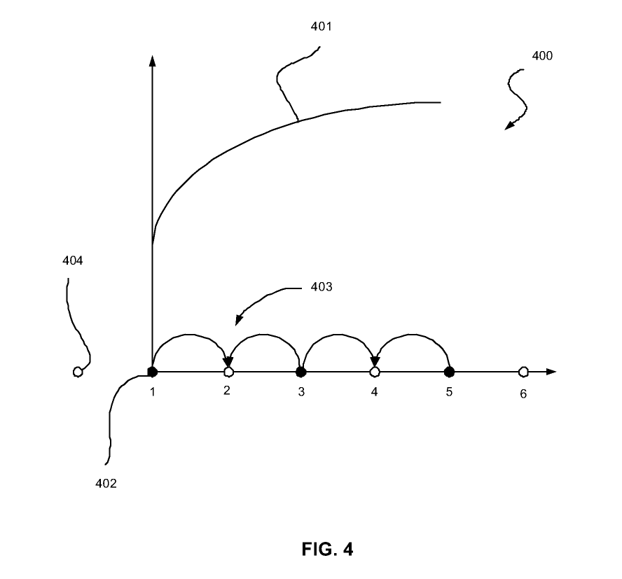

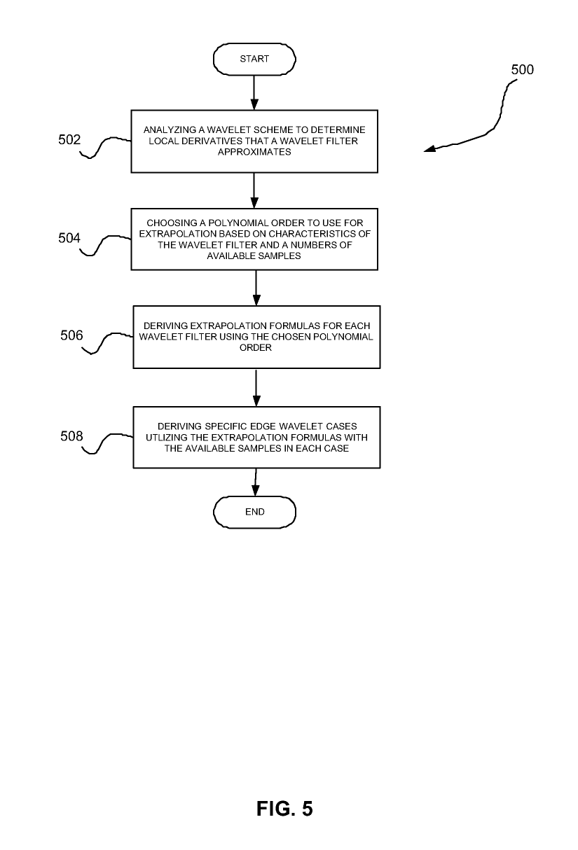

FIG. 4 shows a data structure 400 on which the method 300 is carried out. As shown, during the transformation, a “best fit” 401 may be achieved by an interpolation formula 403 involving a plurality of data values 402. Note operation 302 of the method 300 of FIG. 3. If it is determined that one of the data values 402 is unavailable (see 404), an extrapolation formula may be used to generate such unavailable data value. More optional details regarding one exemplary implementation of the foregoing technique will be set forth in greater detail during reference to FIG. 5.

FIG. 5 illustrates a method 500 for compressing/decompressing data, in accordance with one embodiment. As an option, the present method 500 may be carried out in the context of the transform module 202 of FIG. 2 and the manner in which it carries out a reversible transform. It should be noted, however, that the method 500 may be implemented in any desired context.

The method 500 provides a technique for generating edge filters for a wavelet filter pair. Initially, in operation 502, a wavelet scheme is analyzed to determine local derivatives that a wavelet filter approximates. Next, in operation 504, a polynomial order is chosen to use for extrapolation based on characteristics of the wavelet filter and a numbers of available samples. Next, extrapolation formulas are derived for each wavelet filter using the chosen polynomial order. See operation 506. Still yet, in operation 508, specific edge wavelet cases are derived utilizing the extrapolation formulas with the available samples in each case.

See Appendix A for an optional method of using Vandermonde type matrices to solve for the coefficients. Moreover, additional optional information regarding exemplary extrapolation formulas and related information will now be set forth in greater detail.

One of the transforms specified in the JPEG 2000 standard 1) is the reversible 5-3 transform shown in Equations #1.1 and 1.2.

$$\begin{matrix}Equations \#1 .1 and 1.2 & \\ {Y}_{2 n + 1} = {X}_{2 n + 1} - ⌊ \frac{{X}_{2 n} + {X}_{2 n + 2}}{2} ⌋ & eq 1.1 \\ {Y}_{2 n} = {X}_{2 n} + ⌊ \frac{{Y}_{2 n - 1} + {Y}_{2 n + 1} + 2}{4} ⌋ & eq 1.2\end{matrix}$$

To approximate Y_{2N-1} from the left, one may fit a quadratic polynomial from the left. Approximating the negative of half the 2nd derivative at 2N−1 using the available values yields Equation #1.1.R. See Appendix A for one possible determination of this extrapolating quadratic.

$$\begin{matrix}Equation \#1 .1 . R & \\ {Y}_{2 N - 1} = - \frac{1}{3} ( {X}_{2 N - 1} - ⌊ \frac{3 {X}_{2 N - 2} - {X}_{2 N - 4} + 1}{2} ⌋ ) & eq 1.1 . R\end{matrix}$$

Equation #1.1.R may be used in place of Equation #1.1 when point one is right-most. The apparent multiply by 3 can be accomplished with a shift and add. The division by 3 is trickier. For this case where the right-most index is 2N−1, there is no problem calculating Y_{2N-2} by means of Equation #1.2. In the case where the index of the right-most point is even (say 2N), there is no problem with Equation #1.1, but Equation #1.2 involves missing values. Here the object is to subtact an estimate of Y from the even X using just the previously calculated odd indexed Y s, Y₁ and Y₃ in the case in point. This required estimate at index 2N can be obtained by linear extrapolation, as noted above. The appropriate formula is given by Equation #1.2.R.

$$\begin{matrix}Equation \#1 .2 . R & \\ {Y}_{2 N} = {X}_{2 N} + ⌊ \frac{3 {Y}_{2 N - 1} - {Y}_{2 N - 3} + 2}{4} ⌋ & eq 1.2 . R\end{matrix}$$

A corresponding situation applies at the left boundary. Similar edge filters apply with the required extrapolations from the right (interior) rather than from the left. In this case, the appropriate filters are represented by Equations #1.1.L and 1.2.L.

$$\begin{matrix}Equations \#1 .1 . L and 1.2 . L & \\ {Y}_{0} = - \frac{1}{3} ( {X}_{0} - ⌊ \frac{3 {X}_{1} - {X}_{3} + 1}{2} ⌋ ) & eq 1.1 . L \\ {Y}_{0} = {X}_{0} + ⌊ \frac{3 {Y}_{1} - {Y}_{3} + 2}{4} ⌋ & eq 1.2 . L\end{matrix}$$

The reverse transform fiters can be obtained for these extrapolating boundary filters as for the original ones, namely by back substitution. The inverse transform boundary filters may be used in place of the standard filters in exactly the same circumstances as the forward boundary filters are used. Such filters are represented by Equations #2.1.Rinv, 2.2.Rinv, 2.1.L.inv, and 2.2.L.inv.

$$\begin{matrix}Equations \#2 .1 . Rinv , 2.2 . Rinv , 2.1 . L . inv , 2.2 . L . inv & \\ {X}_{2 N - 1} = - 3 {Y}_{2 N - 1} + ⌊ \frac{3 {X}_{2 N - 2} - {X}_{2 N - 4} + 1}{2} ⌋ & eq 2.1 . R inv \\ {X}_{2 N} = {Y}_{2 N} - ⌊ \frac{3 {Y}_{2 N - 1} - {Y}_{2 N - 3} + 2}{4} ⌋ & eq 2.2 . R inv \\ {X}_{0} = - 3 {Y}_{0} + ⌊ \frac{3 {X}_{1} - {X}_{3} + 1}{2} ⌋ & eq 2.1 . L inv \\ {X}_{0} = {Y}_{0} - ⌊ \frac{3 {Y}_{1} - {Y}_{3} + 2}{4} ⌋ & eq 2.2 . L inv\end{matrix}$$

Thus, one embodiment may utilize a reformulation of the 5-3 filters that avoids the addition steps of the prior art while preserving the visual properties of the filter. See for example, Equations #3.1, 3.1R, 3.2, 3.2L.

$$\begin{matrix}Equations \#3 .1 , 3.1 R , 3.2 , 3.2 L & \\ {Y}_{2 n + 1} = ( {X}_{2 n + 1} + 1 / 2 ) - ⌊ \frac{( {X}_{2 n} + 1 / 2 ) + ( {X}_{2 n + 2} + 1 / 2 )}{2} ⌋ & eq 3.1 \\ {Y}_{2 N + 1} = ( {X}_{2 N + 1} + 1 / 2 ) - ( {X}_{2 N} + 1 / 2 ) & eq 3.1 R \\ ( {Y}_{2 n} + 1 / 2 ) = ( {X}_{2 n} + 1 / 2 ) + ⌊ \frac{{Y}_{2 n - 1} + {Y}_{2 n + 1}}{4} ⌋ & eq 3.2 \\ ( {Y}_{0} + 1 / 2 ) = ( {X}_{0} + 1 / 2 ) + ⌊ \frac{{Y}_{1}}{2} ⌋ & eq 3.2 L\end{matrix}$$

In such formulation, certain coefficients are computed with an offset or bias of ½, in order to avoid the additions mentioned above. It is to be noted that, although there appear to be many additions of ½ in this formulation, these additions need not actually occur in the computation. In Equations #3.1 and 3.1R, it can be seen that the effects of the additions of ½ cancel out, so they need not be applied to the input data. Instead, the terms in parentheses (Y₀+½) and the like may be understood as names for the quantities actually calculated and stored as coefficients, passed to the following level of the wavelet transform pyramid.

Just as in the forward case, the JPEG-2000 inverse filters can be reformulated in the following Equations #4.2, 4.2L, 4.1, 4.1R.

$$\begin{matrix}Equations \#4 .2 , 4.2 L , 4.1 , 4.1 R & \\ ( {X}_{2 n} + 1 / 2 ) = ( {Y}_{2 n} + 1 / 2 ) - ⌊ \frac{{Y}_{2 n - 1} + {Y}_{2 n + 1}}{4} ⌋ & eq 4.2 \\ ( {X}_{0} + 1 / 2 ) = ( {Y}_{0} + 1 / 2 ) - ⌊ \frac{{Y}_{1}}{2} ⌋ & eq 4.2 L \\ ( {X}_{2 n + 1} + 1 / 2 ) = {Y}_{2 n + 1} + ⌊ \frac{( {X}_{2 n} + 1 / 2 ) + ( {X}_{2 n + 2} + 1 / 2 )}{2} ⌋ & eq 4.1 \\ ( {X}_{2 N + 1} + 1 / 2 ) = {Y}_{2 N + 1} + ( {X}_{2 N} + 1 / 2 ) & eq 4.1 R\end{matrix}$$

As can be seen here, the values taken as input to the inverse computation are the same terms produced by the forward computation in Equations #3.1˜3.2L and the corrections by ½ need never be calculated explicitly.

In this way, the total number of arithmetic operations performed during the computation of the wavelet transform is reduced.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### APPENDIX A

One may have three data values, [X_{2N-1}, X_{2N-2} X_{2N-4}], and need three coefficients for the quadratic:

$$[ \begin{matrix}{a}_{0} & {a}_{1} & {a}_{2}\end{matrix} ] [ \begin{matrix}{x}^{0} \\ {x}^{1} \\ {x}^{2}\end{matrix} ] = {a}_{0} + {a}_{1} x + {a}_{2} {x}^{2}$$

The negative of half the 2^{nd} derivative may be

$$- \frac{1}{2} 2 {a}_{2}$$

so interest may only be in a₂. In that case, it is more simple to find the quadratic:

$$[ \begin{matrix}{\tilde{a}}_{0} & {\tilde{a}}_{1} & {\tilde{a}}_{2}\end{matrix} ] [ \begin{matrix}{( x - 2 N )}^{0} \\ {( x - 2 N )}^{1} \\ {( x - 2 N )}^{2}\end{matrix} ] = {\tilde{a}}_{0} + {\tilde{a}}_{1} ( x - 2 N ) + {{\tilde{a}}_{2} ( x - 2 N )}^{2}$$

since

a₂=ã₂

Three linear equations with a Vandermonde type coefficient matrix may be solved.

$$[ \begin{matrix}{\tilde{a}}_{0} & {\tilde{a}}_{1} & {\tilde{a}}_{2}\end{matrix} ] [ \begin{matrix}{( - 1 )}^{0} & {( - 2 )}^{0} & {( - 4 )}^{0} \\ {( - 1 )}^{1} & {( - 2 )}^{1} & {( - 4 )}^{1} \\ {( - 1 )}^{2} & {( - 2 )}^{2} & {( - 4 )}^{2}\end{matrix} ] = [ \begin{matrix}{X}_{2 N - 1} & {X}_{2 N - 2} & {X}_{2 N - 4}\end{matrix} ] \\ [ \begin{matrix}{\tilde{a}}_{0} & {\tilde{a}}_{1} & {\tilde{a}}_{2}\end{matrix} ] = [ \begin{matrix}{X}_{2 N - 1} & {X}_{2 N - 2} & {X}_{2 N - 4}\end{matrix} ] \frac{1}{6} [ \begin{matrix}16 & 12 & 2 \\ - 12 & - 15 & - 3 \\ 2 & 3 & 1\end{matrix} ]$$

Half of the negative of the 2^{nd} derivative is:

$$\begin{matrix}- \frac{1}{2} 2 {a}_{2} = - \frac{1}{2} 2 {\tilde{a}}_{2} \\ = - \frac{1}{6} [ \begin{matrix}{X}_{2 N - 1} & {X}_{2 N - 2} & {X}_{2 N - 4}\end{matrix} ] [ \begin{matrix}2 \\ - 3 \\ 1\end{matrix} ] \\ = - \frac{2}{6} {X}_{2 N - 1} + \frac{3}{6} {X}_{2 N - 2} - \frac{1}{6} {X}_{2 N - 4}\end{matrix}$$

What is claimed is:

1. A method for compressing data, comprising:
receiving data;
encoding the data to generate first compressed data in a first format; and
transcoding the first compressed data to generate second compressed data in a second format.

2. A device for compressing data, comprising:
an encoder configured to generate first compressed data in a first format; and
a transcoder configured to generate second compressed data in a second format.
